(19) United States
(12) Patent Application Publication
(10) Pub. No.: US 2019/0046954 A1
(43) Pub. Date: Feb. 14, 2019

(54) ADSORBENT AND COMPOUND RECOVERY METHOD USING SAME

(71) Applicant: Kyocera Corporation, Kyoto-shi, Kyoto (JP)

(72) Inventor: Takahiko MAKINO, Satsumasendai-shi, Kagoshima (JP)

(21) Appl. No.: 15/764,349

(22) PCT Filed: Sep. 30, 2016
(86) PCT No.: PCT/JP2016/079017

§ 371 Date: Mar. 29, 2018

(30) Foreign Application Priority Data
Oct. 7, 2015 (JP) 2015-199477

(51) Int. Cl. B01J 20/22; C01G 35/00

(52) U.S. Cl. CPC B01J 20/22; C01G 35/003

(57) ABSTRACT

In an embodiment, an adsorbent that absorbs a Group V element compound and contains at least one amino acid selected from basic amino acids, acidic amino acids, and polar uncharged amino acids, or a salt of the amino acid.

### TECHNICAL FIELD

The mode of the present invention relates to an adsorbent that absorbs a Group V element compound and a method of recovering a compound using the same.

### BACKGROUND ART

Group V elements such as tantalum (Ta) and niobium (Nb) are used in members for, for example, capacitors, bio-implants, and high-hardness tool materials. Currently, these members are scrapped after use, and then discarded or processed into an ore. Group V elements are, however, metals having high scarcity values, so that a process for recovering a Group V element and a compound containing a Group V element is required.

Regarding tungsten having a high scarcity value as well as Group V elements, for example, WO2013/151190 (Patent Document 1) discloses a process for recovering a compound containing tungsten. Patent Document 1 discloses a method of adsorbing tungsten compound ions to a microorganism by introducing the microorganism to a tungsten compound solution and adjusting the solution to an acidic level.

While Patent Document 1 discloses the process for recovering a compound containing tungsten, it does not disclose a process for recovering a Group V element. Accordingly, there is a demand for an adsorbent that adsorbs a compound containing a Group V element.

### SUMMARY

In an embodiment, an adsorbent that absorbs a Group V element compound and contains at least one amino acid selected from basic amino acids, acidic amino acids, and polar uncharged amino acids, or a salt of the amino acid.

### BRIEF DESCRIPTION OF THE DRAWINGS

FIG. 1 is a flowchart showing an embodiment of a method of recovering a Group V element compound.

### EMBODIMENTS

The adsorbent that absorbs a Group V element compound in one embodiment and the method of recovering a compound using the same will be specifically described hereinbelow. The adsorbent of the present embodiment adsorbs a Group V element compound ion being present as an ion in solution.

Examples of the Group V element include tantalum and niobium. Examples of the compound of tantalum that is recovered with the adsorbent of the present embodiment include tantalum carbide (TaC), tantalum oxide (Ta₂O₅), tantalum chloride (TaCl₅), lithium tantalate (LiTaO₃), potassium tantalate (KTaO₃), tantalum hafnium carbide (TaₓHf₁₋ₓC_{y}), and hafnium tantalum oxide (TaHfO₃). These compounds are present as oxo acid ion such as tantalic acid ion in solution of which the pH is adjusted as needed.

Examples of the compound of niobium include niobium carbide (NbC), niobium oxide (Nb₂O₅), niobium chloride (NbCl₅), lithium niobate (LiNbO₃), potassium niobate (KNbO₃), and niobium hafnium carbide (NbₓHf₁₋ₓC_{y}). The niobium compound, like the tantalum compound, is present as oxo acid ion such as niobium acid ion in a solution of which the pH is adjusted as needed.

The adsorbent of the present embodiment contains at least one amino acid selected from basic amino acids, acidic amino acids, and polar uncharged amino acids, or a salt of the amino acid. In a solution containing the adsorbent, the Group V element compound ion is adsorbed onto the adsorbent. The Group V element compound ion thus adsorbed onto the adsorbent of the present embodiment is precipitated as a solid content in solution.

The adsorbent with the Group V element compound ion adsorbed thereon can be separated by filtering out the precipitate. Thereafter, by removing or desorbing the adsorbent from the adsorbent with the Group V element compound ion adsorbed thereon, the Group V element compound can be recovered. This makes it possible to recover the Group V element compound through the simple treatment process. Additionally, environmental pollution is reducible because there is no need to use a large amount of chemicals.

The amino acid is any one of a basic amino acid, an acidic amino acid, and a polar uncharged amino acid, or a salt of the amino acid. Specific examples of the basic amino acid include L-arginine, L-lysine, and L-histidine. Specific examples of the acidic amino acid include L-aspartic acid and L-glutamic acid. Specific examples of the polar uncharged amino acid include glycine, tyrosine, threonine, L-asparagine, L-serine, L-cysteine, and L-glutamine.

Among the above-mentioned amino acids, when at least one kind selected from among L-lysine, L-arginine, L-histidine, L-aspartic acid, and L-glutamic acid, or a salt thereof is used, recovery efficiency for the Group V element compound is enhanced. In particular, the Group V element compound is present as oxo acid ion. Therefore, when at least one basic amino acid selected from among L-lysine, L-arginine, and L-histidine, or a salt thereof is used, recovery efficiency for the Group V element compound is further enhanced.

The adsorbent may contain the above-mentioned amino acid alone or may be in the state where the above-mentioned amino acid is carried on a surface of a base material. Organic materials and inorganic materials are usable as a material of the base material. Examples of the organic material include peptides containing a free amino acid, materials that form living bodies such as microorganisms, proteins, and resins. In the present embodiment, the adsorbent in which the base material is composed of peptides containing a free amino acid, materials that form living bodies such as microorganisms, or proteins may be referred to as a biological adsorbent.

The biological adsorbent can take various forms such as powder, pellet formed by molding of powder, gel, or aqueous solution. It is easy to preserve and handle when being in powder or pellet form. When the adsorbent is a solid such as powder or pellet, the solid may be firstly dissolved in another liquid such as water, and then added to a solution containing a Group V element compound.

Examples of the salt of the above-mentioned amino acid include hydrochloride, nitrate, sulfate, acetate, and carbonate. The adsorbent containing the salt of the amino acid may be present as the above-mentioned amino acid in solution when dissolved in a solvent. The adsorbent containing the salt of the amino acid, like the biological adsorbent, may be firstly dissolved in another liquid such as water, and then added to a solution containing Group V element compound ion.

The pH of the solution containing the adsorbent containing the salt of the amino acid and the Group V element compound ion may be adjusted as needed. In the case where the Group V element compound ion is present as anion in solution, for example, if the pH of the solution is adjusted to be lower than the isoelectric point of the amino acid in the adsorbent, the amino acid is protonated, so that the anion of the Group V element compound tends to be easily adsorbed onto the amino acid that is positively charged in the adsorbent.

The adsorbent composed of the salt of the amino acid is capable of increasing the content ratio of the amino acid in the adsorbent as compared with an adsorbent in the form in which the amino acid is carried on the surface of the base material. This leads to enhanced adsorption efficiency for the Group V element compound ion and ensures that a large amount of the Group V element compound ion can be adsorbed with a small amount of the adsorbent. Additionally, when the Group V element compound is recovered after adsorption of the Group V element compound ion, there remains a low content of unnecessary materials that needs to be discarded, and it is easy to handle, thereby reducing manufacturing costs. Furthermore, the adsorbent composed of the salt of the amino acid is not a living organism such as bacteria and microorganisms, and it is therefore easy to preserve and manage the adsorbent.

Although the adsorbent composed of the salt of the amino acid may be in solution form when preserved, the adsorbent in solid form facilitates handling, preservation, and management. In particular, the adsorbent composed of the salt of the amino acid in powder form readily dissolves in solution when used. Alternatively, the adsorbent may be in pellet form in order to facilitate handling of the adsorbent.

In the case where the salt of the amino acid that is composed mainly of at least one of L-lysine, L-arginine, and L-histidine is used, the adsorption efficiency of the adsorbent is enhanced. Among these salts, L-lysine hydrochloride is stable and inexpensive. The description “being composed mainly of at least one of L-lysine, L-arginine, and L-histidine” means that a ratio of a total mass of the salt of L-lysine, the salt of L-arginine, and the salt of L-histidine in the adsorbent is 50% by mass or more relative to a total amount of the adsorbent.

A total amount of the salt of L-lysine, the salt of L-arginine, and the salt of L-histidine each being present in the adsorbent is preferably 90% by mass or more. This ensures that a large amount of a Group V element compound can be adsorbed with a small amount of the adsorbent. The total amount of the salt of L-lysine, the salt of L-arginine, and the salt of L-histidine each being present in the adsorbent is more preferably in a range of 95% by mass or more.

Among the salts of the amino acid, the salt of L-glutamic acid is inexpensive and can reduce the cost of the adsorbent. In particular, monosodium glutamate is stable and inexpensive.

The amino acid is not limited to only one kind. For example, the salt of another amino acid such as L-lysine, L-arginine, and L-histidine may be added together with the salt of L-glutamic acid. Additionally, when the salt of the amino acid to be used is insoluble in alcohol, the adsorbent may be dissolved in water and used as an aqueous solution.

As in the case of using peptide containing a free amino acid as a base material, the adsorbent may contain a free amino acid in solution. In such a case, when an aqueous solution of the adsorbent containing a free amino acid and a solution containing the Group V element compound ion are mixed, the Group V element compound ion tends to be easily adsorbed.

When the adsorbent contains a free amino acid, the content of the free amino acid is not particularly limited. When the adsorbent contains a total amount of 0.5% by mass or more of the free amino acid relative to a total amount of a solid obtainable by drying the adsorbent, namely, a solid content of the adsorbent, the recovery efficiency of the Group V element compound can be improved.

When the adsorbent contains a total amount of less than 0.5% by mass of the free amino acid, a free amino acid may be separately added or increased by a method to be described later. Specifically, as in the case where the adsorbent is composed of a biological adsorbent, when the adsorbent contains an amino acid that does not contribute to adsorption reaction (hereinafter referred to as “inert amino acid” in some cases), in order to enhance the content ratio of the free amino acids in the adsorbent, the inert amino acid may be converted into a free amino acid by carrying out processing to cleave the peptide bonds of the inert amino acid being present in the adsorbent. Examples of the inert amino acid include amino acids that are present at an intermediate position in amino acids bonded by peptide bonds, and amino acids that are present at internal positions not exposed to the surface of the adsorbent.

For example, as the processing to cleave the peptide bonds being present in the microorganism that is used as a biological adsorbent, an existing processing method may be used. Specifically, the protein constituting the microorganism is decomposed by a protein decomposition enzyme such as trypsin, lysyl endopeptidase, and v8 protease. This makes it possible to convert at least a part of the inert amino acid contained in the body of the microorganism into a free amino acid.

As another method of converting the inert amino acid into a free amino acid, there is also an effective method with which protein is decomposed by subjecting the adsorbent to, for example, heating treatment at 60° C. or above, boiling treatment, or heating and pressurizing treatment using an autoclave apparatus or the like. When the adsorbent is not a living organism such as a microorganism, or when the adsorbent need not be preserved in solution but is preservable as a solid as in the case of inorganic matter in which a microorganism has been decomposed, neither a large-scale facility for cultivation and preservation nor maintenance therefor is necessary, thus leading to a downsized facility.

Next, a method of recovering a Group V element compound using the adsorbent of the present embodiment will be described below.

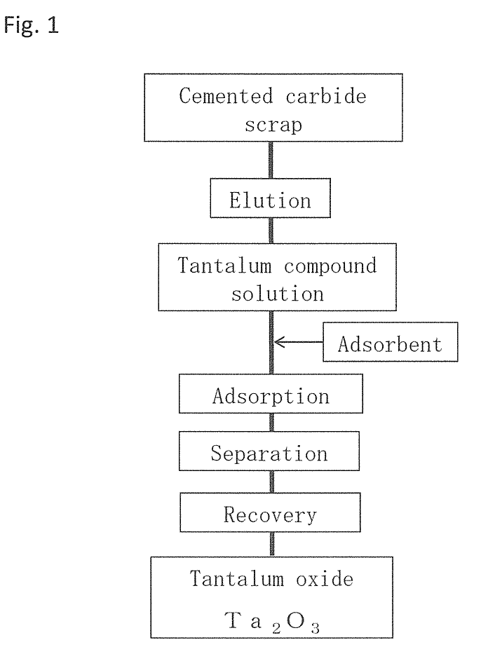

As one embodiment of the method of recovering a Group V element compound, a method of recovering tantalum oxide from tool scrap mainly composed of cemented carbide will be described specifically with reference to FIG. 1. As the method of recovering a Group V element compound, a tantalum compound in the following embodiment may be substituted for, for example, a niobium compound.

The cemented carbide is mainly composed of tungsten carbide (WC) or the like and the tool scrap contains a Group V element compound such as tantalum carbide (TaC). Examples of the tool scrap include scrap generated during manufacturing process of cemented carbide tools or the like, hard scrap of used tools and the like, and powdery soft scrap such as grinding sludge.

The tool scrap employs, in addition to WC and TaC, iron, nickel, cobalt, or the like as a binding phase, and may contain, as additive ingredients, TiC, NbC, VC, Cr₃C₂ or the like as needed. Examples of the tool scrap containing a target cemented carbide include cutting tools (e.g., cutting inserts, drills, and end mills), metal molds (e.g., molding rolls and molding dies), and civil engineering and mining tools (e.g., oil-well drilling tools and rock crushing tools). Although the process of recovering a Group V element compound from wastes is described below in the present embodiment, without limitation thereto, this is also applicable for extracting a Group V element compound from an ore.

First, a Group V element compound ion eluted from a member (tool scrap) containing a Group V element compound (tantalum compound) is dissolved in a solvent containing alcohol to thereby obtain a first solution containing the compound ion. Examples of the alcohol include lower alcohols such as methanol and ethanol.

A second solution containing the adsorbent of the above embodiment is mixed with the first solution thus obtained, to thereby obtain a third solution. For example, when the adsorbent is a biological adsorbent, the second solution is obtained by adding the adsorbent so that the adsorbent amounts to 600 g to 150 kg per 1 m³ of the first solution whose tantalum concentration is adjusted to 0.1 to 10 mmol/l (a tantalum concentration is 0.1 to 10 mmol relative to 1 liter of the first solution).

The biological adsorbent may be processed so as to contain a total amount of 0.5% by mass or more of the free amino acid relative to a total amount of a solid obtainable by drying the adsorbent, namely, a solid content of the adsorbent.

Specifically, processing to cleave the peptide bonds of the inert amino acid being present in the biological substance is carried out by heating, pressurizing, or adding an enzyme to the biological substance. This makes it possible to convert the inert amino acid into a free amino acid, so that the adsorption efficiency of the adsorbent can be enhanced.

When the adsorbent is composed of the salt of the amino acid, the adsorbent is added to the first solution at such a content ratio that a total amount of addition of the salt of the amino acid in the adsorbent is 0.5 to 30 mol relative to 1 mol of a tantalum ingredient of the tantalum compound. This ensures that a large amount of the tantalum compound ion can be adsorbed.

At this time, the total amount of addition of the salt of the amino acid may be 0.5 to 300 g/l relative to the first solution. Such values can prevent an increase in viscosity of the solution, thereby preventing a decrease in recovery efficiency for the tantalum compound. In particular, when the adsorbent is composed of the salt of amino acid, the viscosity of the solution is less likely to increase, thereby improving working efficiency.

Temperature needs to be controlled according to activity of the amino acid contained in the adsorbent, and it is usually kept at room temperature. The pH of the third solution is adjusted, for example, by using hydrochloric acid or the like so that the amino acid is protonated. This causes adsorption of the tantalum compound ion onto the adsorbent. The pH adjustment of the third solution may be carried out after the first and second solutions are mixed but the pHs of the first and second solutions before mixing may be adjusted to a desired pH in advance.

The third solution has a pH of less than 7 (acidity). When the amino acid is L-lysine, L-arginine, and L-histidine, a suitable pH is 4 or less, preferably 1 to 3, and more preferably 1 to 2.3. When the amino acid is L-glutamic acid, a suitable pH is 1.5 or less. This leads to an enhanced recovery rate for the tantalum compound.

When the adsorbent is the salt of the amino acid, an adsorption reaction completes within one hour. The adsorption reaction proceeds within one minute, but the adsorption reaction time may be controlled, taking into consideration of the mixed state of the third solution.

Subsequently, the adsorbent with the tantalum compound ion adsorbed thereon is separated from the third solution. For example, the adsorbent with the tantalum compound ion adsorbed thereon is dehydrated by means of centrifugal separation or the like. Then, impurities are removed by, for example, pure water cleaning as needed. This makes it possible to easily separate the adsorbent with the tantalum compound ion adsorbed thereon.

Thereafter, for example, the adsorbent with the tantalum compound ion adsorbed thereon is dried, and then burned at a temperature of 300° C. or higher in the atmosphere to thereby remove organic ingredients containing the adsorbent. This makes it possible to recover the tantalum compound. According to the present embodiment, the tantalum compound is oxidized into tantalum oxide (Ta₂O₅) by burning the adsorbent in an oxidizing atmosphere, to thereby obtain tantalum oxide as a Group V element compound.

Although the tantalum oxide thus obtained is usable in various applications such as capacitors, the tantalum oxide may be substituted for tantalum carbide when used as a raw material for a cemented carbide. To substitute the tantalum oxide for the tantalum carbide, for example, the tantalum oxide is heat-treated at a temperature of 500° C. or higher in a reducing atmosphere and is then subjected to reduction and carbonization.

In the method of recovering the tantalum compound according to the present embodiment, since the amount of chemicals used and the amount of waste are small, and the treatment process is simple, the tantalum compound can be recovered at low cost.

The tantalum compound ion may be desorbed from the adsorbent in a state where the adsorbent separated from the third solution is dissolved in a solution of which the pH is adjusted to a different pH from the third solution. The suspension containing the adsorbent and the tantalum compound ion desorbed from the adsorbent is subjected to centrifugal separation or filtration, thereby allowing separation into the adsorbent and the solution containing the tantalum compound ion. The adsorbent thus separated can be recovered and recycled. Since this method allows the adsorbent to be recycled, the cost required for the adsorbent can be reduced when an expensive adsorbent is used.

Thus, the method of recovering the tantalum compound according to the present embodiment is capable of recovering the tantalum compound in the simple process sequence at low cost.

### EXAMPLE 1

Added was 0.05 g of tantalum chloride (TaCl₅) to 5 mL of ethanol, and the added mixture was dissolved by stirring, to prepare a first solution. Further, 0.62 g of lysine hydrochloride was added to 43 mL of water, and the added mixture was stirred to prepare a second solution having lysine hydrochloride dissolved therein. Then, the second solution was added to the first solution such that the ratio of lysine hydrochloride to 0.01 mmol of TaO₃— in the first solution is approximately 20 times, to thereby prepare a third solution. The pH was adjusted to 2 by adding hydrochloric acid (HCl) to the third solution. After the pH adjustment, the third solution was stirred at 25° C. for 60 minutes.

The third solution thus stirred was subjected to centrifugal separation, and a tantalum concentration in a supernatant liquid was measured by ICP atomic emission spectroscopy. The tantalum concentration in the supernatant liquid and a tantalum concentration before adding the adsorbent were compared with each other. Then, when a concentration of the unrecovered tantalum compound and a concentration of the recovered tantalum compound were calculated, a recovery rate for the tantalum compound was 30%.

### EXAMPLE 2

An adsorption test of the tantalum compound was carried out in the same conditions as in Example 1, except that lysine hydrochloride in the second solution was replaced with monosodium glutamate in Example 1. The result of the adsorption test showed that the recovery rate for the tantalum compound was 99%.

1. An adsorbent that adsorbs a Group V element compound,
comprising at least one amino acid selected from the group comprising of basic amino acids, acidic amino acids, polar uncharged amino acids, salts thereof, and combinations thereof.

2. The adsorbent according to claim 1, wherein the amino acid is selected from the group comprising of L-lysine, L-arginine, L-histidine, L-aspartic acid, and L-glutamic acid, salts thereof, and combinations thereof.

3. The adsorbent according to claim 2, wherein the amino acid is at least one basic amino acid selected from the group comprising of L-lysine, L-arginine, and L-histidine, salts thereof, and combinations thereof.

4. A method of recovering a compound, comprising the steps of:
removing a Group V element compound ion from a member containing a Group V element compound by immersing the member in a solvent containing alcohol to obtain a first solution containing the Group V compound ion;
mixing the first solution with a second solution containing the adsorbent defined in claim 1 to obtain a third solution;
adjusting a pH of the third solution to adsorb the compound ion onto the adsorbent;
separating the adsorbent with the compound ion adsorbed thereon from the third solution; and
recovering the compound from the adsorbent with the compound ion adsorbed thereon.

5. The method of recovering a compound according to claim 4, wherein the step of adjusting a pH of the third solution includes adjusting a pH of the third solution to be lower than an isoelectric point of the amino acid contained in the adsorbent.

6. The method of recovering a compound according to claim 4, wherein the step of adjusting a pH of the third solution includes adjusting a pH of the third solution to range from 1 to 3.
